(19) United States
(12) Patent Application Publication
(10) Pub. No.: US 2022/0052557 A1
(43) Pub. Date: Feb. 17, 2022

(54) Dynamic Digital Ping Power

(71) Applicant: AIRA, Inc., Chandler, AZ (US)

(72) Inventor: Eric Heindel Goodchild, Phoenix, AZ (US)

(21) Appl. No.: 17/400,063

(22) Filed: Aug. 11, 2021

Related U.S. Application Data
(60) Provisional application No. 63/066,219, filed on Aug. 15, 2020.

(51) Int. Cl. H02J 50/12; H02J 50/40; H04L 27/02

(52) U.S. Cl. CPC H02J 50/12; H02J 7/00041; H04L 27/02; H02J 50/402

(57) ABSTRACT

Systems, methods and apparatus for wireless charging are disclosed. One method performed at a wireless charging device includes transmitting a first ping at a first power level through a power transmitting coil in the wireless charging device and, until a response is received from a chargeable device or until a ping with a maximum power level has been transmitted, determining whether a voltage measured at the power transmitting coil is modulated with the response and transmitting a next ping at an increased power level through the power transmitting coil in the wireless charging device when the response is not received. The method may include determining a charging configuration for transferring power to the chargeable device when the response is received.

### PRIORITY CLAIM

This application claims priority to and the benefit of provisional patent application No. 63/066,219 filed in the United States Patent Office on Aug. 15, 2020, and the entire content of this application is incorporated herein by reference as if fully set forth below in their entirety and for all applicable purposes.

### TECHNICAL FIELD

The present invention relates generally to wireless charging of batteries, including batteries in mobile computing devices and more particularly to techniques for detecting and communicating with devices to be charged.

### BACKGROUND

Wireless charging systems have been deployed to enable certain types of devices to charge internal batteries without the use of a physical charging connection. Devices that can take advantage of wireless charging include mobile processing and/or communication devices. Standards, such as the Qi standard defined by the Wireless Power Consortium enable devices manufactured by a first supplier to be wirelessly charged using a charger manufactured by a second supplier. Standards for wireless charging are optimized for relatively simple configurations of devices and tend to provide basic charging capabilities.

Conventional wireless charging systems typically use a “Digital Ping” to determine if a receiving device is present on or proximate to a transmitting coil in a base station for wireless charging. The transmitter coil has an inductance (L) and, a resonant capacitor that has a capacitance (C) is coupled to the transmitting coil to obtain a resonant LC circuit.

Improvements in wireless charging capabilities are required to identify and support continually increasing complexity of mobile devices and changing form factors.

### BRIEF DESCRIPTION OF THE DRAWINGS

FIG. 1 illustrates an example of a charging cell that may be employed to provide a charging surface in accordance with certain aspects disclosed herein.

FIG. 2 illustrates an example of an arrangement of charging cells provided on a single layer of a segment of a charging surface that may be adapted in accordance with certain aspects disclosed herein.

FIG. 3 illustrates an example of an arrangement of charging cells when multiple layers are overlaid within a segment of a charging surface that may be adapted in accordance with certain aspects disclosed herein.

FIG. 4 illustrates the arrangement of power transfer areas provided by a charging surface that employs multiple layers of charging cells configured in accordance with certain aspects disclosed herein.

FIG. 5 illustrates a wireless transmitter that may be provided in a charger base station in accordance with certain aspects disclosed herein.

FIG. 6 illustrates a microcontroller that supports ASK demodulation in accordance with certain aspects disclosed herein.

FIG. 7 illustrates examples of encoding schemes that may be adapted to digitally encode messages exchanged between power receivers and power transmitters in accordance with certain aspects disclosed herein.

FIG. 8 illustrates an example of a charging surface of a wireless charging device.

FIG. 9 illustrates an example of a communication interface in a wireless charging device that may be configured to support multi-frequency ASK modulation in accordance with certain aspects disclosed herein.

FIG. 10 illustrates an example of a Digital Ping procedure in accordance with certain aspects disclosed herein.

FIG. 11 is flowchart illustrating an example of a method for dynamic power management in Digital Ping procedure executed in accordance with certain aspects of this disclosure.

FIG. 12 illustrates one example of an apparatus employing a processing circuit that may be adapted according to certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of wireless charging systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a processor-readable storage medium. A processor-readable storage medium, which may also be referred to herein as a computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), Near Field Communications (NFC) token, random access memory (RAM), read only memory (ROM), programmable ROM (PROM), erasable PROM (EPROM), electrically erasable PROM (EEPROM), a register, a removable disk, a carrier wave, a transmission line, and any other suitable medium for storing or transmitting software. The computer-readable medium may be resident in the processing system, external to the processing system, or distributed across multiple entities including the processing system. Computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

### Overview

Certain aspects of the present disclosure relate to systems, apparatus and methods applicable to wireless charging devices and techniques. Charging cells may be configured with one or more inductive coils to provide a charging surface that can charge one or more devices wirelessly. The location of a device to be charged may be detected through sensing techniques that associate location of a device to changes in a physical characteristic centered at a known location on the charging surface. Sensing of location may be implemented using capacitive, resistive, inductive, touch, pressure, load, strain, and/or another appropriate type of sensing.

In one aspect of the disclosure, an apparatus has a battery charging power source, one or more charging cells provided on a charging surface of the wireless charging device and a controller. The controller may be configured to transmit a first ping at a first power level through a power transmitting coil in the wireless charging device, and may then optionally repeat determining whether a voltage measured at the power transmitting coil is modulated with the response, and transmitting a next ping at an increased power level through the power transmitting coil in the wireless charging device when the response is not received until a response is received from a chargeable device or until a ping with a maximum power level has been transmitted. The controller may be configured to determine a charging configuration for transferring power to the chargeable device when the response is received.

### Charging Cells

According to certain aspects disclosed herein, a charging surface may be provided using charging cells that are deployed adjacent to the charging surface. In one example the charging cells are deployed in accordance with a honeycomb packaging configuration. A charging cell may be implemented using one or more coils that can each induce a magnetic field along an axis that is substantially orthogonal to the charging surface adjacent to the coil. In this description, a charging cell may refer to an element having one or more coils where each coil is configured to produce an electromagnetic field that is additive with respect to the fields produced by other coils in the charging cell, and directed along or proximate to a common axis. In some examples, the coils in a charging cell are formed using traces on a printed circuit board. In some examples, a coil in a charging cell is formed by spirally winding a wire to obtain a planar coil or a coil that has a generally cylindrical outline. In one example, Litz wire may be used to form a planar or substantially flat winding that provides a coil with a central power transfer area.

In some implementations, a charging cell includes coils that are stacked along a common axis and/or that overlap such that they contribute to an induced magnetic field substantially orthogonal to the charging surface. In some implementations, a charging cell includes coils that are arranged within a defined portion of the charging surface and that contribute to an induced magnetic field within the substantially orthogonal portion of the charging surface associated with the charging cell. In some implementations, charging cells may be configurable by providing an activating current to coils that are included in a dynamically defined charging cell. For example, a charging device may include multiple stacks of coils deployed across a charging surface, and the charging device may detect the location of a device to be charged and may select some combination of stacks of coils to provide a charging cell adjacent to the device to be charged. In some instances, a charging cell may include, or be characterized as a single coil. However, it should be appreciated that a charging cell may include multiple stacked coils and/or multiple adjacent coils or stacks of coils.

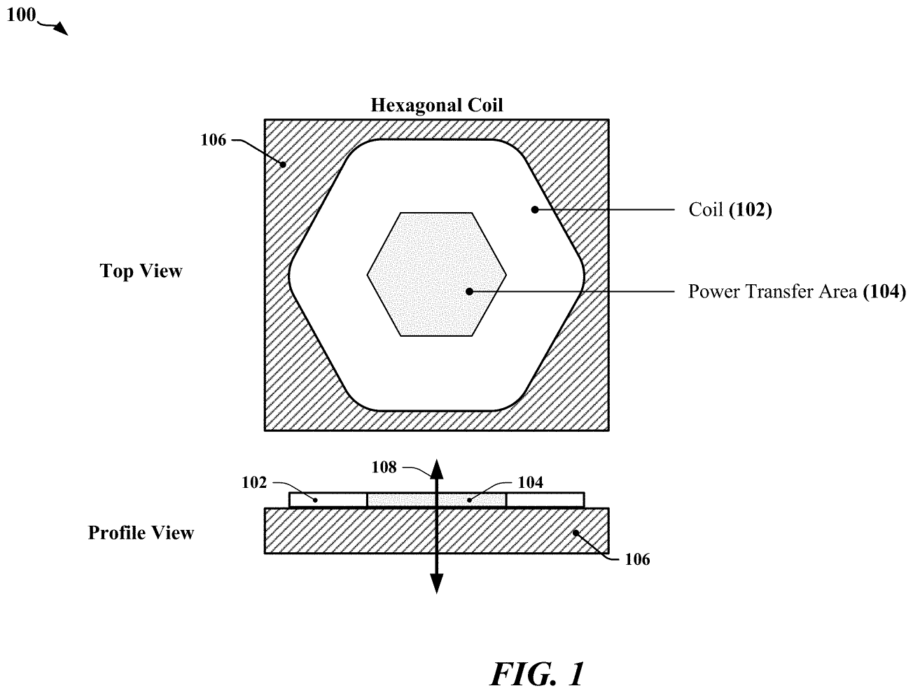

FIG. 1 illustrates an example of a charging cell 100 that may be deployed and/or configured to provide a charging surface of a charging device. As described herein, the charging surface may include an array of charging cells 100 provided on one or more substrates 106. A circuit comprising one or more integrated circuits (ICs) and/or discrete electronic components may be provided on one or more of the substrates 106. The circuit may include drivers and switches used to control currents provided to coils used to transmit power to a receiving device. The circuit may be configured as a processing circuit that includes one or more processors and/or one or more controllers that can be configured to perform certain functions disclosed herein. In some instances, some or all of the processing circuit may be provided external to the charging device. In some instances, a power supply may be coupled to the charging device.

The charging cell 100 may be provided in close proximity to an outer surface area of the charging device, upon which one or more devices can be placed for charging. The charging device may include multiple instances of the charging cell 100. In one example, the charging cell 100 has a substantially hexagonal shape that encloses one or more coils 102, which may be constructed using conductors, wires or circuit board traces that can receive a current sufficient to produce an electromagnetic field in a power transfer area 104. In various implementations, some coils 102 may have a shape that is substantially polygonal, including the hexagonal charging cell 100 illustrated in FIG. 1. Other implementations provide coils 102 that have other shapes. The shape of the coils 102 may be determined at least in part by the capabilities or limitations of fabrication technology, and/or to optimize layout of the charging cells on a substrate 106 such as a printed circuit board substrate. Each coil 102 may be implemented using wires, printed circuit board traces and/or other connectors in a spiral configuration. Each charging cell 100 may span two or more layers separated by an insulator or substrate 106 such that coils 102 in different layers are centered around a common axis 108.

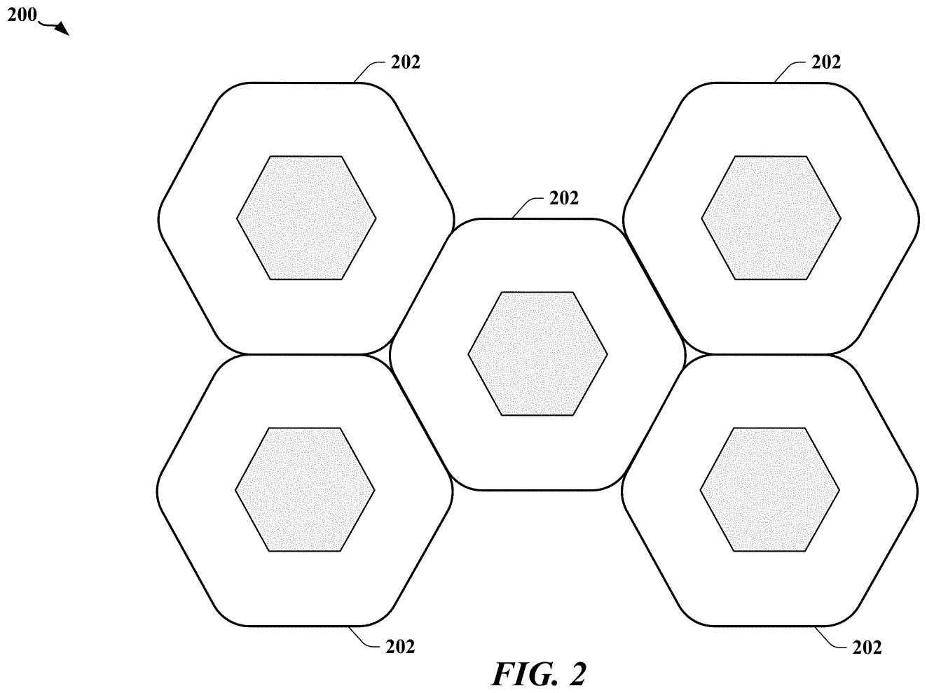

FIG. 2 illustrates an example of an arrangement 200 of charging cells 202 provided on a single layer of a segment of a charging surface of a charging device that may be adapted in accordance with certain aspects disclosed herein. The charging cells 202 are arranged according to a honeycomb packaging configuration. In this example, the charging cells 202 are arranged end-to-end without overlap. This arrangement can be provided without through-hole or wire interconnects. Other arrangements are possible, including arrangements in which some portion of the charging cells 202 overlap. For example, wires of two or more coils may be interleaved to some extent.

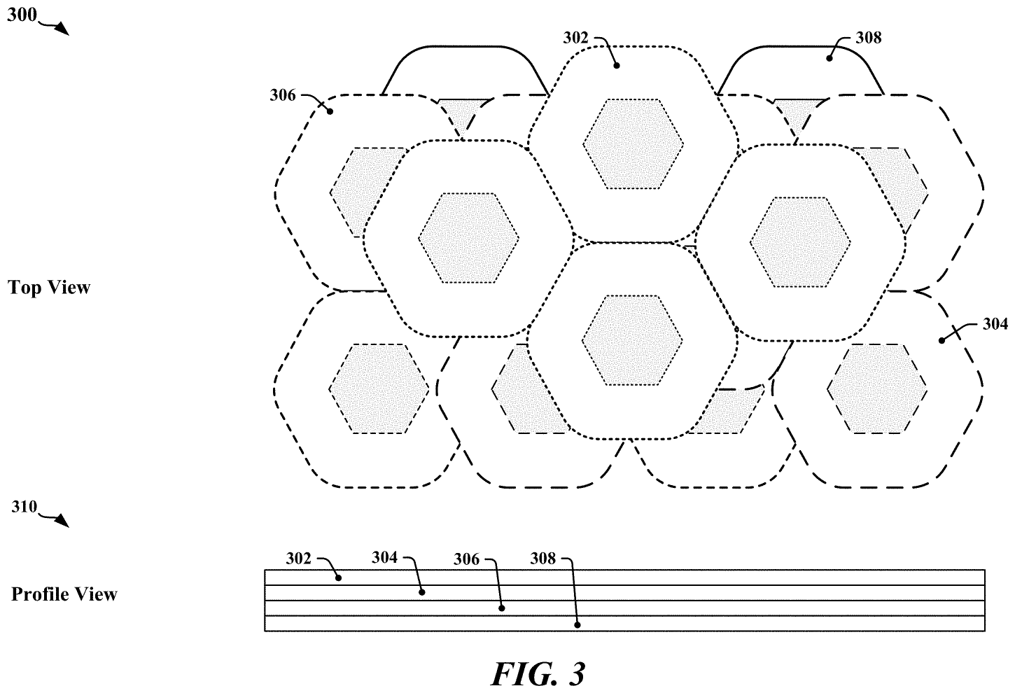

FIG. 3 illustrates an example of an arrangement of charging cells from two perspectives 300, 310 (e.g., top and profile views) when multiple layers are overlaid within a segment of a charging surface that may be adapted in accordance with certain aspects disclosed herein. Layers of charging cells 302, 304, 306, 308 are provided within a segment of a charging surface. The charging cells within each layer of charging cells 302, 304, 306, 308 are arranged according to a honeycomb packaging configuration. In one example, the layers of charging cells 302, 304, 306, 308 may be formed on a printed circuit board that has four or more layers. The arrangement of charging cells 100 can be selected to provide complete coverage of a designated charging area that is adjacent to the illustrated segment. The charging cells may be 302, 304, 306, 308 illustrated in FIG. 3 correspond to power transfer areas provided by transmitting coils that are polygonal in shape. In other implementations, the charging coils may comprise spirally wound planar coils constructed from wires, each being wound to provide a substantially circular power transfer area. In the latter examples, multiple spirally wound planar coils may be deployed in stacked planes below the charging surface of a wireless charging device.

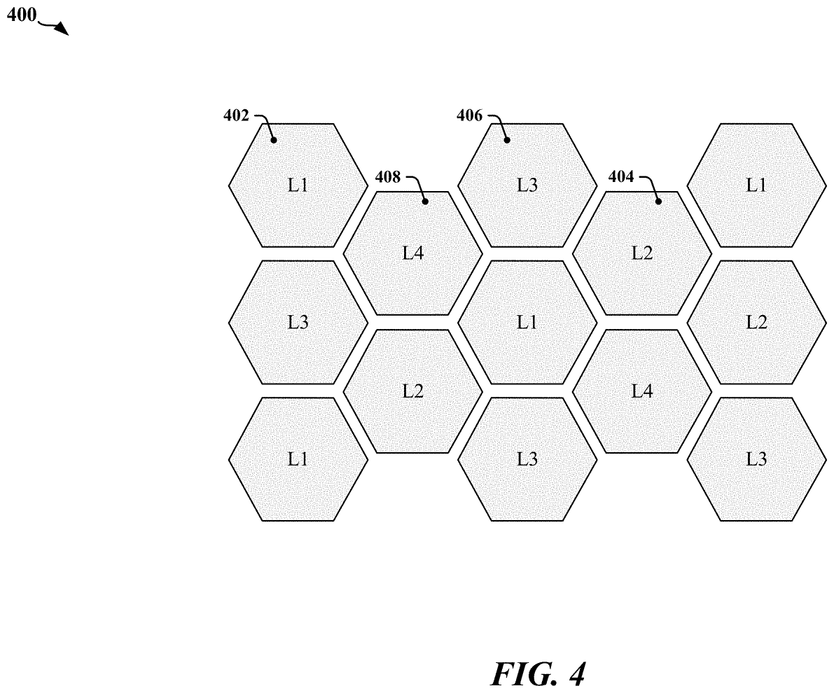

FIG. 4 illustrates the arrangement of power transfer areas provided in a charging surface 400 that employs multiple layers of charging cells configured in accordance with certain aspects disclosed herein. The illustrated charging surface is constructed from four layers of charging cells 402, 404, 406, 408, which may correspond to the layers of charging cells 302, 304, 306, 308 in FIG. 3. In FIG. 4, each power transfer area provided by a charging cell in the first layer of charging cells 402 is marked “L1”, each power transfer area provided by a charging cell in the second layer of charging cells 404 is marked “L2”, each power transfer area provided by a charging cell in the third layer of charging cells 406 is marked “L3”, and each power transfer area provided by a charging cell in the fourth layer of charging cells 408 is marked “L4”.

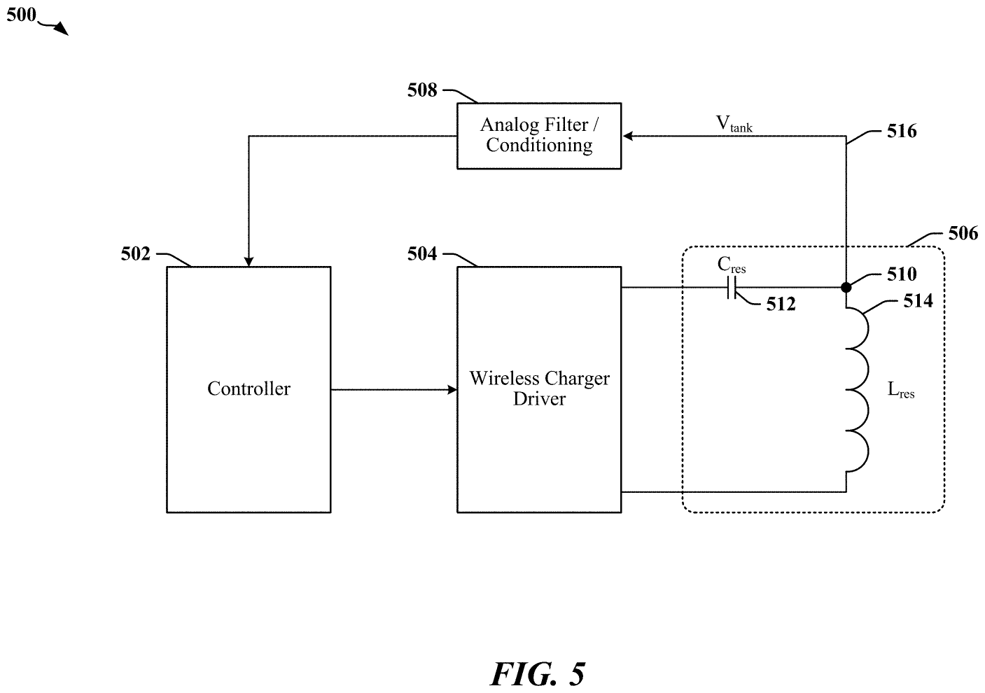

FIG. 5 illustrates a wireless transmitter 500 that may be provided in a charger base station. A controller 502 may receive a feedback signal filtered or otherwise processed by a conditioning circuit 508. The controller may control the operation of a driver circuit 504 that provides an alternating current to a resonant circuit 506 that includes a capacitor 512 and inductor 514. The voltage 516 measured at an LC node 510 of the resonant circuit 506. The resonant circuit 506 may also be referred to herein as a tank circuit, an LC tank circuit and/or as an LC tank.

One of the most commonly employed protocols used for wirelessly interconnecting a power transmitter to a power receiver is the Qi protocol. The Qi protocol can enable the power receiver to control the power transmitter wirelessly. The exchange of messages from power receiver to power transmitter is typically effected by way of an Amplitude Shift Keying (ASK) protocol. A digital signal processor (DSP) may be employed to decode the ASK signal from the voltage or current in the tank circuit of the inductive power transfer device. Interrupts may be used to measure timing between level changes on the ASK signal. In one example, an external demodulation circuit may cooperate with a timer provided by a microcontroller to generate interrupts used to calculate time elapsed between edges or transitions in a signal. The ASK-modulated signal can be decoded based on a series of time intervals measured between the edges or transitions. In another example, a DSP or another type of processor may be used to demodulate the ASK-modulated signal using digital signal processing methods. In these and other examples, expensive resources may be consumed to obtain a relatively simple decoding system.

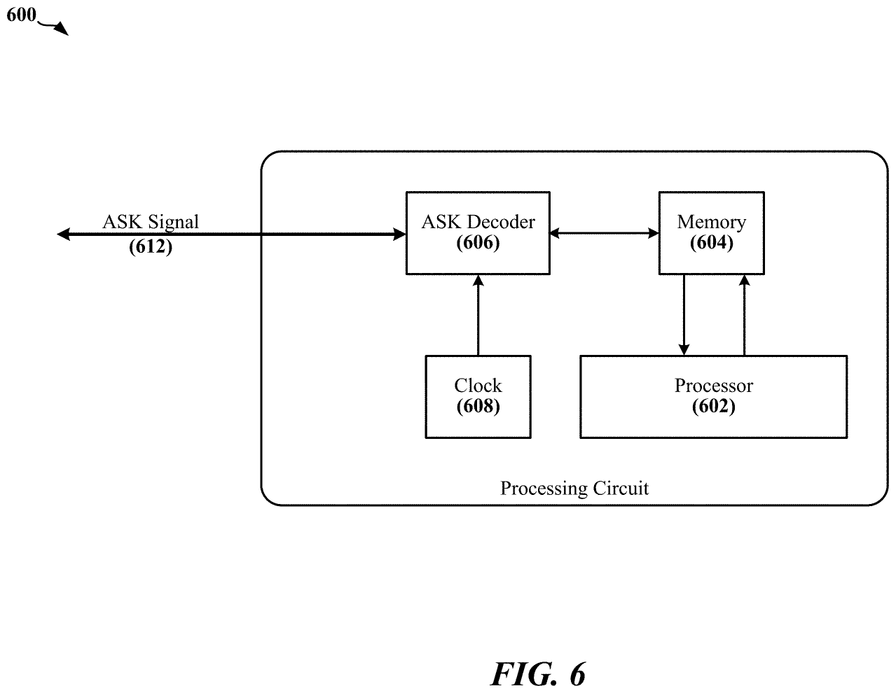

FIG. 6 illustrates an example of a processing circuit 600 that may be configured to receive and decode ASK-modulated signal. The processing circuit 600 includes a processor 602 which may be coupled to a memory device 604 and/or registers that can store messages to be transmitted using an ASK-modulated signal 612 and/or messages decoded from a received ASK-modulated signal 612. The processing circuit 600 includes an ASK decoder 606 that may be implemented using hardware, software or some combination of hardware and software. The ASK decoder 606 may use a clock signal received from a clock generation or recovery circuit to control timing of the transmitted ASK-modulated signal 612 and to control sampling and decoding of a received ASK-modulated signal 612.

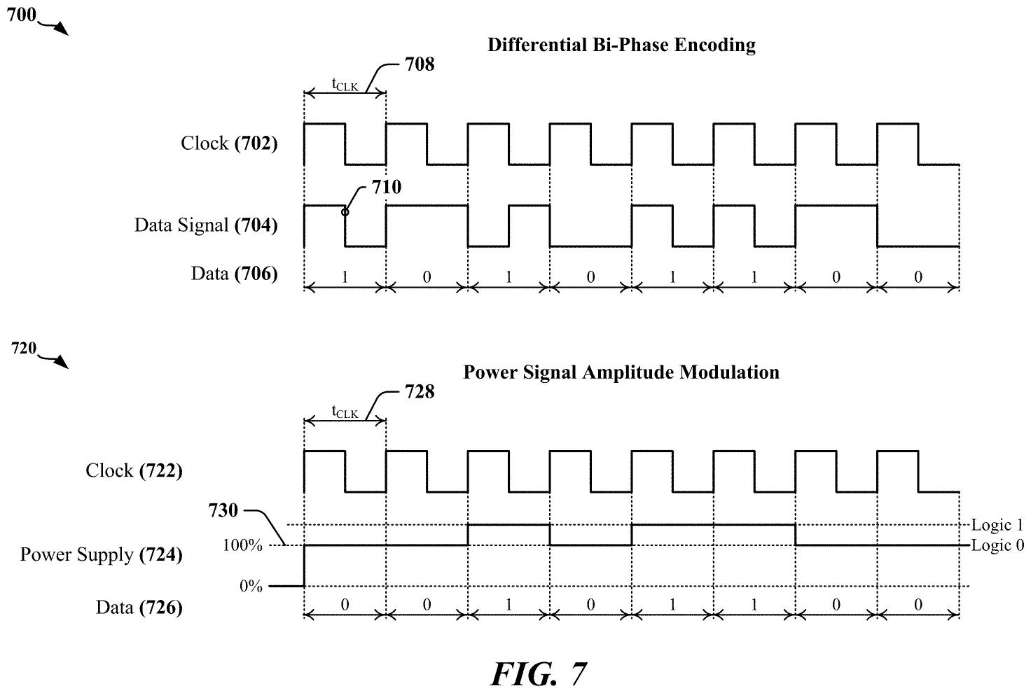

FIG. 7 illustrates examples of encoding schemes 700, 720 that may be adapted to digitally encode messages exchanged between power receivers and power transmitters. In the first example, a differential bi-phase encoding scheme 700 encodes binary bits in the phase of a data signal 704. In the illustrated example, each bit of a data byte 706 is encoded in a corresponding cycle 708 of an encoder clock signal 702. The value of each bit is encoded in a phase change detectable by identifying the presence or absence of a transition 710 in the data signal 704 during the corresponding cycle 708.

In the second example, a power supply 724 is encoded using a power signal amplitude encoding scheme 720. In the illustrated example, binary bits of a data byte 726 are encoded in level of the power supply 724. Each bit of the data byte 726 is encoded in a corresponding cycle 728 of an encoder clock signal 722. The value of each bit is encoded in the voltage level of the power supply 724 relative to a nominal 100% voltage level 730 of the power supply 724 during the corresponding cycle 708.

### Passive Ping

In accordance with certain aspects disclosed herein, location of an object or other chargeable device may be detected based on changes in some property of the electrical conductors that form coils in a charging cell. Measurable differences in properties of the electrical conductors may include changes in capacitance, resistance, inductance and/or temperature when an object is placed in proximity to one or more coils. In some examples, placement of an object on the charging surface can affect the measurable resistance, capacitance, inductance of a coil located near the point of placement. In some implementations, circuits may be provided to measure changes in resistance, capacitance, and/or inductance of one or more coils located near the point of placement. In some implementations, sensors may be provided to enable location sensing through detection of changes in touch, pressure, load and/or strain in the charging surface. Conventional techniques used in current wireless charging applications for detecting devices employ “ping” methods that drive the transmitting coil and consume substantial power (e.g., 100-200 mW). The field generated by the transmitting coil is used to detect a receiving device.

Wireless charging devices may be adapted in accordance with certain aspects disclosed herein to support a low-power discovery technique that can replace and/or supplement conventional ping transmissions. A conventional ping is produced by driving a resonant LC circuit that includes a transmitting coil of a base station. The base station then waits for an ASK-modulated response from the receiving device. A low-power discovery technique may include utilizing a passive ping to provide fast and/or low-power discovery. According to certain aspects, a passive ping may be produced by driving a network that includes the resonant LC circuit with a fast pulse that includes a small amount of energy. The fast pulse excites the resonant LC circuit and causes the network to oscillate at its natural resonant frequency until the injected energy decays and is dissipated. In one example, the fast pulse may have a duration corresponding to a half cycle of the resonant frequency of the network and/or the resonant LC circuit. When the base station is configured for wireless transmission of power within the frequency range 100 kHz to 200 kHz, the fast pulse may have a duration that is less than 2.5 μs.

The passive ping may be characterized and/or configured based on the natural frequency at which the network including the resonant LC circuit rings, and the rate of decay of energy in the network. The ringing frequency of the network and/or resonant LC circuit may be defined as:

$$ω = \frac{1}{\sqrt{L C}} \qquad ( Eq . 1 )$$

The rate of decay is controlled by the quality factor (Q factor) of the oscillator network, as defined by:

$$Q = \frac{1}{R} \sqrt{\frac{L}{C}} \qquad ( Eq . 2 )$$

Equations 1 and 2 show that resonant frequency is affected by L and C, while the Q factor is affected by L, C and R. In a base station provided in accordance with certain aspects disclosed herein, the wireless driver has a fixed value of C determined by the selection of the resonant capacitor. The values of L and R are determined by the wireless transmitting coil and by an object or device placed adjacent to the wireless transmitting coil.

The wireless transmitting coil is configured to be magnetically coupled with a receiving coil in a device placed in close proximity to the transmitting coil, and to couple some of its energy into the proximate device to be charged. The L and R values of the transmitter circuit can be affected by the characteristics of the device to be charged, and/or other objects within close proximity of the transmitting coil. As an example, if a piece of ferrous material with a high magnetic permeability placed near the transmitter coils can increase the total inductance (L) of the transmitter coil, resulting in a lower resonant frequency, as shown by Equation 1. Some energy may be lost through heating of materials due to eddy current induction, and these losses may be characterized as an increase the value of R thereby lowering the Q factor, as shown by Equation 2.

A wireless receiver placed in close proximity to the transmitter coil can also affect the Q factor and resonant frequency. The receiver may include a tuned LC network with a high Q which can result in the transmitter coil having a lower Q factor. The resonant frequency of the transmitter coil may be reduced due to the addition of the magnetic material in the receiver, which is now part of the total magnetic system. Table 1 illustrates certain effects attributable to different types of objects placed in close proximity to the transmitter coil.

TABLE 1

| Object | L | R | Q | Frequency |
|---|---|---|---|---|
| None present | Base Value | Base value | Base Value (High) | Base Value |
| Ferrous | Small Increase | Large Increase | Large Decrease | Small Decrease |
| Non-ferrous | Small Decrease | Large Increase | Large Decrease | Small Increase |
| Wireless Receiver | Large Increase | Small Decrease | Small Decrease | Large Decrease |

### Dynamic Power Management for Digital Ping

A Digital Ping is produced by delivering power to the resonant LC circuit for a duration of time while the transmitter listens for a response from a receiving device. In one example, power is applied for a nominal 90 ms during a Digital Ping. The response may be provided in a signal encoded using ASK modulation. In one example, a typical transmitting base station may ping as frequently as 12.5 times a second (period=1/80 ms) with a power level of 80 mJ per second, such that the digital ping discovery procedures consumes 1 W. According to certain aspects disclosed herein, coils in one or more charging cells may be selectively activated to provide an optimal Digital Ping that accommodates chargeable devices with different receiver sensitivities.

Certain aspects of this disclosure relate to detection, selecting a charging configuration, and charging of different types of chargeable devices. A charging configuration may define a charging zone on a charging surface, a set of charging cells or one or more transmitting coils to be used for transmitting power wirelessly to a chargeable device. A charging configuration may define frequency, phase or amplitude of currents to be provided to one or more transmitting coils used for charging a chargeable device.

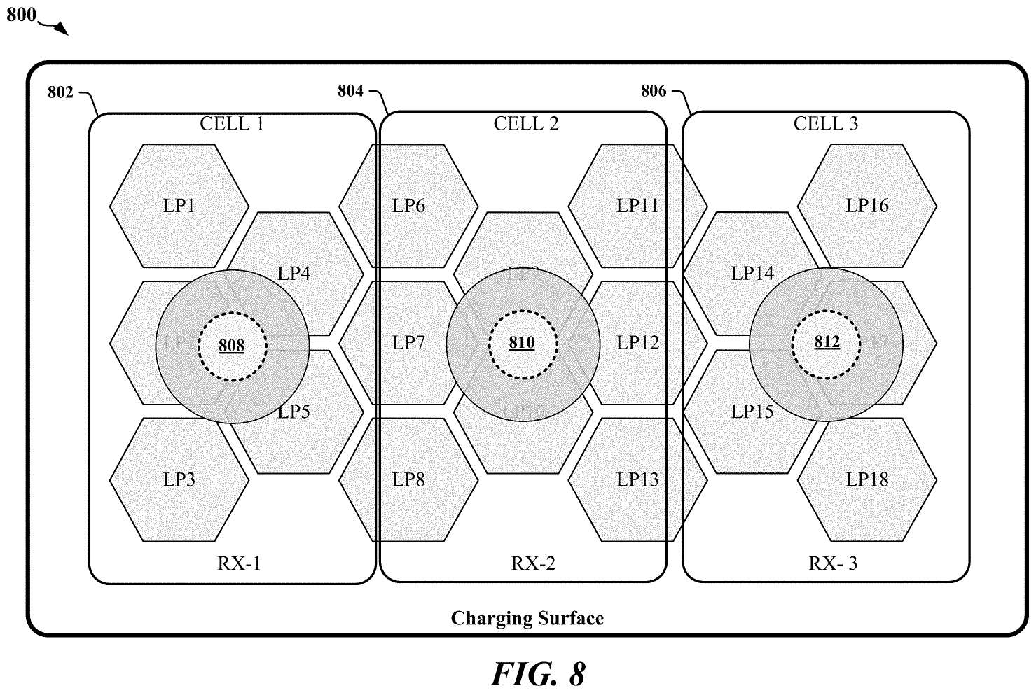

FIG. 8 illustrates a charging surface 800 of a wireless charging device upon which three charging cells 802, 804, 806 are defined. In the illustrated example, each of the charging cells 802, 804, 806 may be used to independently transfer power wirelessly to a chargeable device. A controller of the wireless charging device may define a charging configuration for each active charging cell 802, 804, 806. In the illustrated example, receiving coils 808, 810, 812 of the active chargeable devices are located near the center of an associated charging cell 802, 804, 806. In operation, the receiving coils 808, 810, 812 can be electromagnetically coupled with one or more transmitting coils (marked LP-1 through LP-18) in the charging surface 800. In the illustrated example, the wireless charging device may include multiple drivers that may be configurable to provide a charging current to transmitting coils in a charging cell. The wireless charging device may additionally be capable of concurrent device discovery and/or concurrent control of the receiving coils 808, 810, 812 through the chargeable devices that include the receiving coils 808, 810, 812.

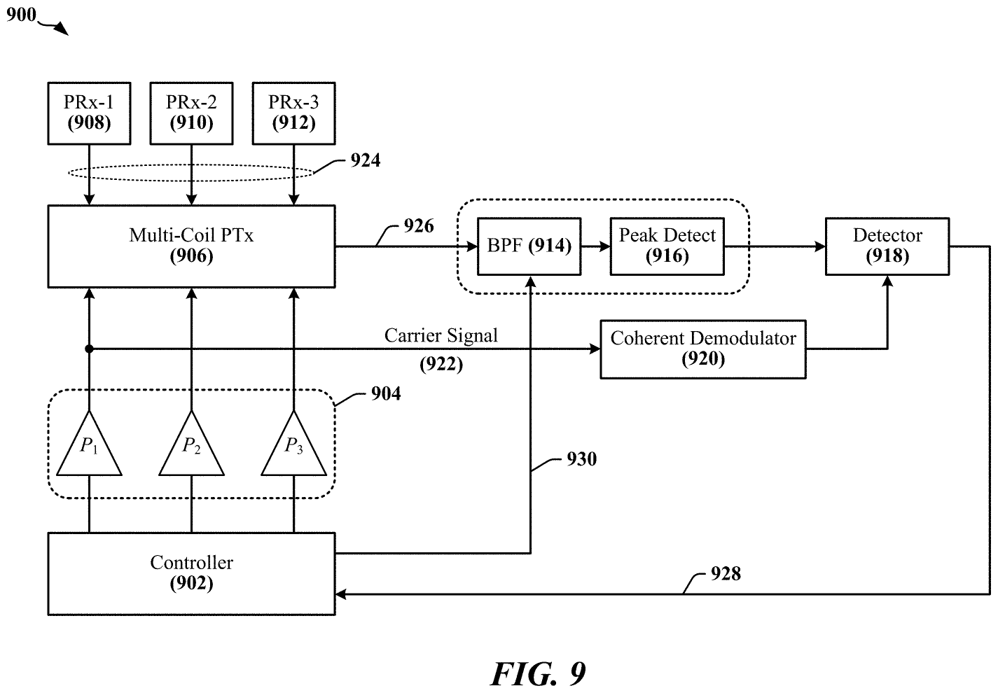

FIG. 9 illustrates an example of a communication interface 900 in a wireless charging device that supports multi-frequency ASK modulation. Certain wireless charging protocols define a nominal frequency and power level of the charging current to be provided to the power transmitter for power transfer. The operating frequency also serves as the carrier frequency for ASK modulation. The wireless charging device can determine capability and configuration information by decoding ASK-modulated signals 924 received from one or more receiving devices 908, 910, 912. The wireless charging device may define charging configurations for the receiving devices 908, 910, 912 based on the received capability and configuration information. The receiving devices 908, 910, 912 may have different power requirements, and some of the receiving devices 908, 910, 912 may have power receiving circuits that have different sensitivities or may be rated for different maximum and minimum received power levels.

In the illustrated communication interface 900, a multi-device wireless charger has one or more multi-coil power transmitting circuits 906 that are controlled by a processor, sequencer, state machine or other controller 902. A controller 902 may configure a set of drivers 904 to provide a charging current to each active charging coil in the power transmitting circuits 906. In one example, each active charging coil is coupled to a different receiving device 908, 910, 912. In some instances, a charging current may be provided to multiple coils that are electromagnetically coupled to one or more receiving coils in a single receiving device. The controller 902 may configure the set of drivers 904 to provide charging currents at different power levels.

ASK-modulated signals 926 extracted from the power transmitting circuits 906 may be provided to band-pass filters 914 configured by a band-select signal 930 provided by the controller 902. The band-select signal 930 may configure the band-pass filter 914 to block frequency components that are not associated with the channel provided for ASK encoding. The charging current may be provided at different frequencies to accommodate resonance modifications caused by coupling that is not nominal, for example. In some implementations the band-select signal 930 defines the center frequency and bandwidth of the band-pass filter 914. A filtered version of the ASK-modulated signal 926 is provided to a peak detector 916 that feeds a detector 918. The detector 918 also receives the output of a coherent demodulator 920, which is fed a representation of the carrier signal 922 to enable decoding of information 928 carried in the ASK-modulated signal 926.

The power transmitting circuits 906 may be configured with an operating frequency and power levels for charging based on received capability and configuration information determined from one or more Digital Pings. The wireless charger may be unaware of the precise location or distance of the receiving devices 908, 910, 912 with respect to a surface of the wireless charger and is typically further unaware of the capability and sensitivity of receiving circuits in the receiving devices 908, 910, 912. Accordingly, the wireless charger transmits the Digital Ping at a nominal power level.

In many applications, the wireless charger may encounter a large range of device types and sizes that can have very different responses to the same digital ping amplitude. A ping amplitude that is considered low by one device may be close to the maximum limits of a more sensitive device. Consequently, the transmission power for digital ping may be scaled to accommodate the most-sensitive chargeable device that may be placed on a charging surface of the charging device. In many conventional systems, a tradeoff may be made between failure to detect low-sensitivity devices and protection of the circuits in high-sensitivity devices.

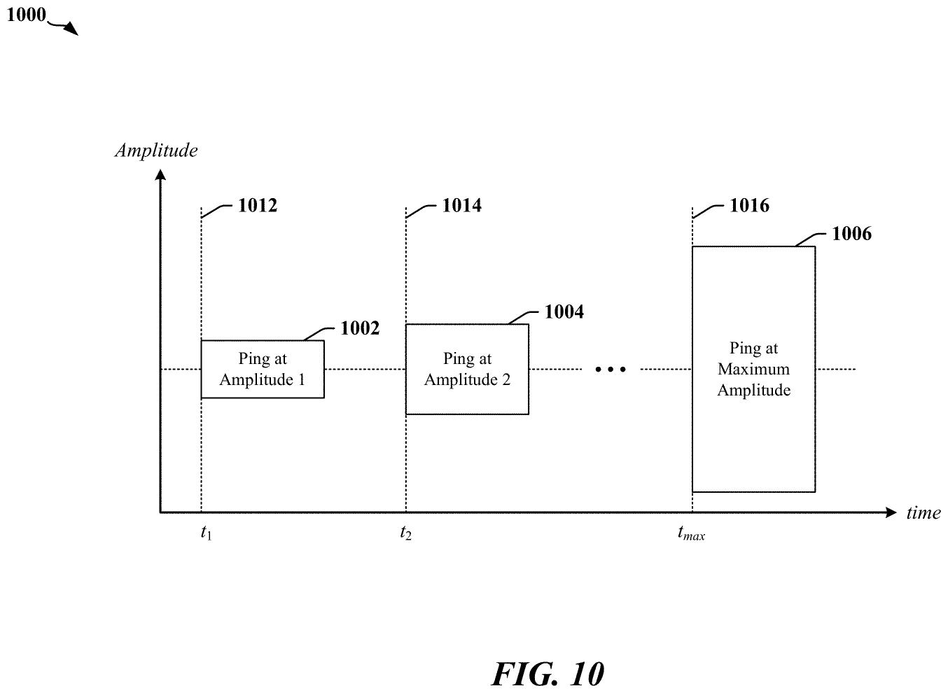

The communication interface 900 may be adapted in accordance with certain aspects of this disclosure to provide a dynamic Digital Ping that is transmitted at increasing power levels. FIG. 10 illustrates an example of a Digital Ping procedure 1000 in which successive Digital Pings 1002, 1004, 1006 are transmitted with increasing power levels, commencing with a lowest amplitude Digital Ping 1002 that can be safely received by all types of chargeable devices that may potentially be placed on a charging surface of the charging device. Subsequent Digital Pings 1004, 1006 are transmitted with increasing amplitudes until a response is received or until a Digital Ping 1006 has been transmitted at a maximum power level.

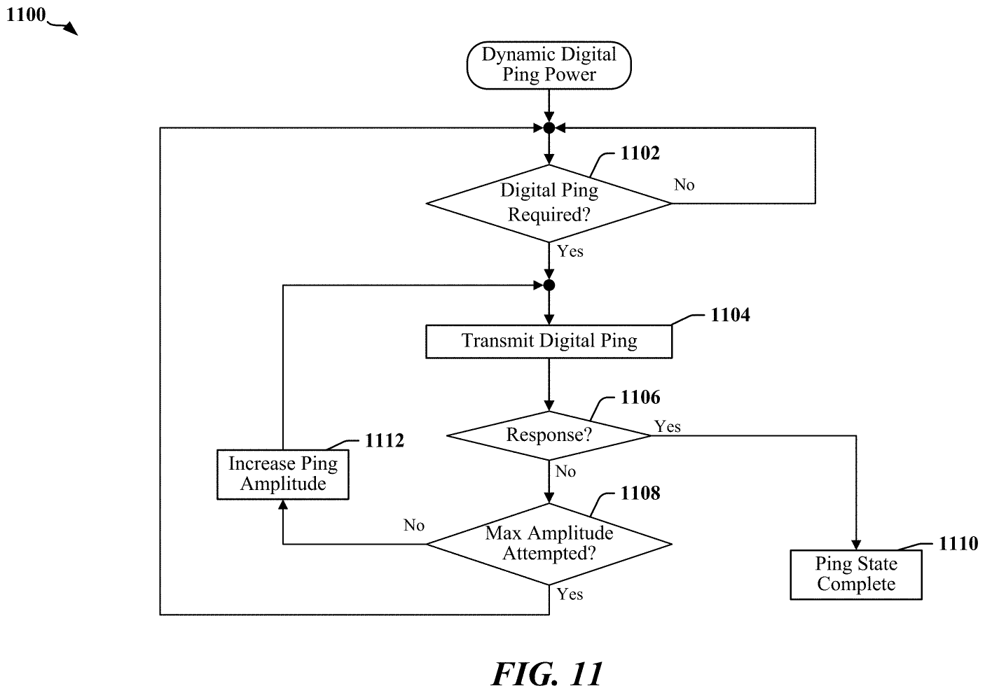

FIG. 11 is flowchart 1100 illustrating an example of a method for dynamic power management in a Digital Ping procedure executed in accordance with certain aspects of this disclosure. The method may be performed by a controller in a multi-device wireless charger. At block 1102, the controller may determine that a Digital Ping is required or requested. In one example, the controller may perform a Digital Ping procedure through each transmitting coil at a configured repetition rate. In another example, the controller may determine that an object has been placed on a surface of the charger and may determine that the Digital Ping is needed to ascertain the type of object, properties, or charging capabilities of the object. When the controller determines that a Digital Ping is required or requested at block 1102, the controller may set an initial, safe amplitude for the Digital Ping and proceed to block 1104, where the controller may transmit a Digital Ping. At block 1106, the controller may determine whether a response to the Digital Ping has been received. If a response to the Digital Ping has been received, then the controller may terminate the Ping Procedure at block 1110 and proceed to define a charging configuration based on information received in the response. If no response has been received then at block 1108, the controller may determine whether all amplitudes for Digital Ping have been attempted. If all amplitudes for Digital Ping have been attempted, the controller may determine that no chargeable device is present and may terminate the procedure, returning to block 1102. If all amplitudes for Digital Ping have not been attempted, the controller may increase Digital Ping amplitude at block 1112 and continue by transmitting a next Digital Ping at block 1104.

### Example of a Processing Circuit

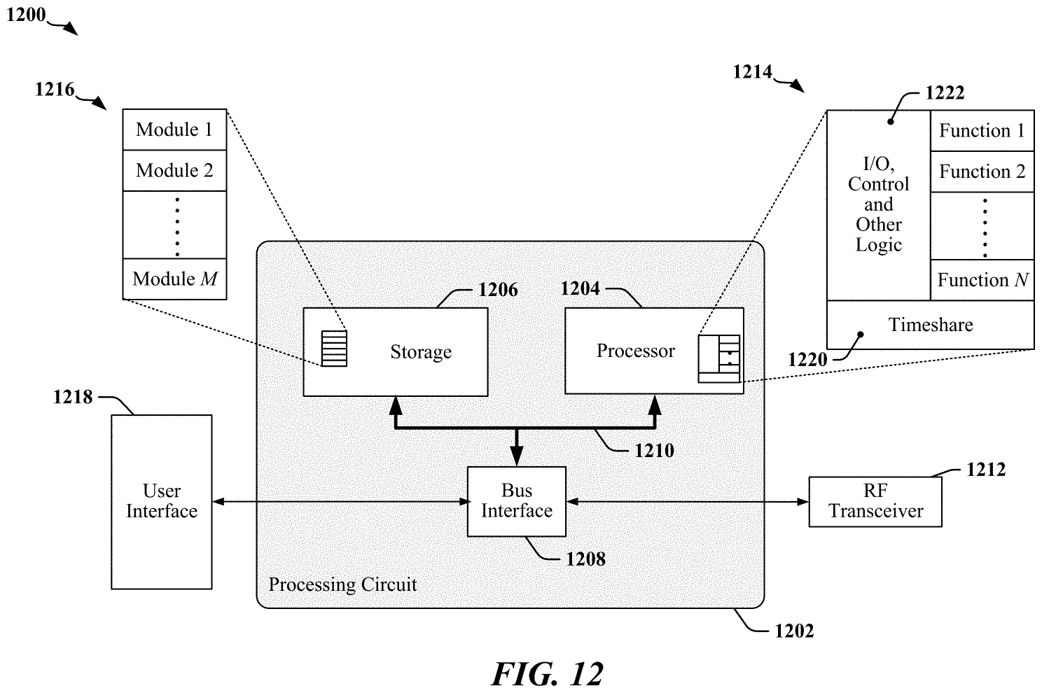

FIG. 12 illustrates an example of a hardware implementation for an apparatus 1200 that may be incorporated in a charging device or in a receiving device that enables a battery to be wirelessly charged. In some examples, the apparatus 1200 may perform one or more functions disclosed herein. In accordance with various aspects of the disclosure, an element, or any portion of an element, or any combination of elements as disclosed herein may be implemented using a processing circuit 1202. The processing circuit 1202 may include one or more processors 1204 that are controlled by some combination of hardware and software modules. Examples of processors 1204 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1204 may include specialized processors that perform specific functions, and that may be configured, augmented or controlled by one of the software modules 1216. The one or more processors 1204 may be configured through a combination of software modules 1216 loaded during initialization, and further configured by loading or unloading one or more software modules 1216 during operation.

In the illustrated example, the processing circuit 1202 may be implemented with a bus architecture, represented generally by the bus 1210. The bus 1210 may include any number of interconnecting buses and bridges depending on the specific application of the processing circuit 1202 and the overall design constraints. The bus 1210 links together various circuits including the one or more processors 1204, and storage 1206. Storage 1206 may include memory devices and mass storage devices and may be referred to herein as computer-readable media and/or processor-readable media. The storage 1206 may include transitory storage media and/or non-transitory storage media.

The bus 1210 may also link various other circuits such as timing sources, timers, peripherals, voltage regulators, and power management circuits. A bus interface 1208 may provide an interface between the bus 1210 and one or more transceivers 1212. In one example, a transceiver 1212 may be provided to enable the apparatus 1200 to communicate with a charging or receiving device in accordance with a standards-defined protocol. Depending upon the nature of the apparatus 1200, a user interface 1218 (e.g., keypad, display, speaker, microphone, joystick) may also be provided, and may be communicatively coupled to the bus 1210 directly or through the bus interface 1208.

A processor 1204 may be responsible for managing the bus 1210 and for general processing that may include the execution of software stored in a computer-readable medium that may include the storage 1206. In this respect, the processing circuit 1202, including the processor 1204, may be used to implement any of the methods, functions and techniques disclosed herein. The storage 1206 may be used for storing data that is manipulated by the processor 1204 when executing software, and the software may be configured to implement any one of the methods disclosed herein.

One or more processors 1204 in the processing circuit 1202 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1206 or in an external computer-readable medium. The external computer-readable medium and/or storage 1206 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1206 may also include, by way of example, a carrier wave, a transmission line, and any other suitable medium for transmitting software and/or instructions that may be accessed and read by a computer. Computer-readable medium and/or the storage 1206 may reside in the processing circuit 1202, in the processor 1204, external to the processing circuit 1202, or be distributed across multiple entities including the processing circuit 1202. The computer-readable medium and/or storage 1206 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1206 may maintain and/or organize software in loadable code segments, modules, applications, programs, etc., which may be referred to herein as software modules 1216. Each of the software modules 1216 may include instructions and data that, when installed or loaded on the processing circuit 1202 and executed by the one or more processors 1204, contribute to a run-time image 1214 that controls the operation of the one or more processors 1204. When executed, certain instructions may cause the processing circuit 1202 to perform functions in accordance with certain methods, algorithms and processes described herein.

Some of the software modules 1216 may be loaded during initialization of the processing circuit 1202, and these software modules 1216 may configure the processing circuit 1202 to enable performance of the various functions disclosed herein. For example, some software modules 1216 may configure internal devices and/or logic circuits 1222 of the processor 1204 and may manage access to external devices such as a transceiver 1212, the bus interface 1208, the user interface 1218, timers, mathematical coprocessors, and so on. The software modules 1216 may include a control program and/or an operating system that interacts with interrupt handlers and device drivers, and that controls access to various resources provided by the processing circuit 1202. The resources may include memory, processing time, access to a transceiver 1212, the user interface 1218, and so on.

One or more processors 1204 of the processing circuit 1202 may be multifunctional, whereby some of the software modules 1216 are loaded and configured to perform different functions or different instances of the same function. The one or more processors 1204 may additionally be adapted to manage background tasks initiated in response to inputs from the user interface 1218, the transceiver 1212, and device drivers, for example. To support the performance of multiple functions, the one or more processors 1204 may be configured to provide a multitasking environment, whereby each of a plurality of functions is implemented as a set of tasks serviced by the one or more processors 1204 as needed or desired. In one example, the multitasking environment may be implemented using a timesharing program 1220 that passes control of a processor 1204 between different tasks, whereby each task returns control of the one or more processors 1204 to the timesharing program 1220 upon completion of any outstanding operations and/or in response to an input such as an interrupt. When a task has control of the one or more processors 1204, the processing circuit is effectively specialized for the purposes addressed by the function associated with the controlling task. The timesharing program 1220 may include an operating system, a main loop that transfers control on a round-robin basis, a function that allocates control of the one or more processors 1204 in accordance with a prioritization of the functions, and/or an interrupt driven main loop that responds to external events by providing control of the one or more processors 1204 to a handling function.

In one example, the apparatus 1200 includes or operates as a wireless charging apparatus that has a battery charging power source coupled to a charging circuit, a plurality of charging cells and a controller, which may be included in one or more processors 1204. The plurality of charging cells may be configured to provide a charging surface. At least one coil may be configured to direct an electromagnetic field through a charge transfer area of each charging cell.

The controller may be configured to transmit a first ping at a first power level through a power transmitting coil in the wireless charging device. The controller may transmit additional pings with increasing power levels. The first ping and subsequent pings may be Digital Pings. For example, until a response is received from a chargeable device or until a ping with a maximum power level has been transmitted, the controller may determine whether a voltage measured at the power transmitting coil is modulated with the response, and transmit a next ping at an increased power level through the power transmitting coil in the wireless charging device when the response is not received. The controller may be further configured to determine a charging configuration for transferring power to the chargeable device when the response is received.

The instructions may further cause the processing circuit to determine the charging configuration based on information identifying a capabilities or configuration of the chargeable device provided in the response. The instructions may further cause the processing circuit to determine the charging configuration information identifying a requested charging current provided in the response. The voltage measured at the power transmitting coil may be modulated using ASK. The instructions may further cause the processing circuit to determine that the chargeable device is present on or near a charging surface of the wireless charging device, and to transmit the first ping based on determined presence of the chargeable device on or near the charging surface. Presence of the chargeable device on or near the charging surface is determined using a passive ping procedure.

In another example, the storage 1206 maintains instructions and information where the instructions are configured to cause the one or more processors 1204 to transmit a first ping at a first power level through a power transmitting coil in the wireless charging device. The controller may transmit additional pings with increasing power levels. The first ping and subsequent pings may be Digital Pings. For example, until a response is received from a chargeable device or until a ping with a maximum power level has been transmitted, the instructions may cause the one or more processors 1204 to determine whether a voltage measured at the power transmitting coil is modulated with the response, and transmit a next ping at an increased power level through the power transmitting coil in the wireless charging device when the response is not received. The instructions may be further configured to cause the one or more processors 1204 to determine a charging configuration for transferring power to the chargeable device when the response is received.

The instructions may be further configured to cause the one or more processors 1204 to determine the charging configuration based on information identifying a capabilities or configuration of the chargeable device provided in the response. The instructions may be further configured to cause the one or more processors 1204 to determine the charging configuration information identifying a requested charging current provided in the response. The voltage measured at the power transmitting coil is modulated using ASK modulation. The instructions may be further configured to cause the one or more processors 1204 to determine that the chargeable device is present on or near a charging surface of the wireless charging device, and to transmit the first ping based on determined presence of the chargeable device on or near the charging surface. Presence of the chargeable device on or near the charging surface is determined using a passive ping procedure.

Some implementation examples are described in the following numbered clauses:
1. A method performed at a wireless charging device, comprising: transmitting a first ping at a first power level through a power transmitting coil in the wireless charging device; until a response is received from a chargeable device or until a ping with a maximum power level has been transmitted: determining whether a voltage measured at the power transmitting coil is modulated with the response; and transmitting a next ping at an increased power level through the power transmitting coil in the wireless charging device when the response is not received; and determining a charging configuration for transferring power to the chargeable device when the response is received.
2. The method as described in clause 1, further comprising: determining the charging configuration based on information identifying a capabilities or configuration of the chargeable device provided in the response.
3. The method as described in clause 1 or clause 2, further comprising: determining the charging configuration from information identifying a requested charging current provided in the response.
4. The method in any of clauses 1-3, wherein the voltage measured at the power transmitting coil is modulated using Amplitude Shift Key (ASK) modulation.
5. The method in any of clauses 1-4, further comprising: determining that the chargeable device is present on or near a charging surface of the wireless charging device; and transmitting the first ping based on determined presence of the chargeable device on or near the charging surface.
6. The method as described in clause 5, wherein presence of the chargeable device on or near the charging surface is determined using a passive ping procedure.
7. A wireless charging device, comprising: one or more charging cells provided on a charging surface of the wireless charging device; and a controller configured to: transmit a first ping at a first power level through a power transmitting coil in the wireless charging device; until a response is received from a chargeable device or until a ping with a maximum power level has been transmitted: determine whether a voltage measured at the power transmitting coil is modulated with the response; and transmit a next ping at an increased power level through the power transmitting coil in the wireless charging device when the response is not received; and determine a charging configuration for transferring power to the chargeable device when the response is received.
8. The charging device as described in clause 7, wherein the controller configured to: determine the charging configuration based on information identifying a capabilities or configuration of the chargeable device provided in the response.
9. The charging device as described in clause 7 or clause 8, wherein the controller configured to: determining the charging configuration from information identifying a requested charging current provided in the response.
10. The charging device as described in any of clauses 7-9, wherein the voltage measured at the power transmitting coil is modulated using Amplitude Shift Key (ASK) modulation.
11. The charging device as described in any of clauses 7-10, wherein the controller configured to: determining that the chargeable device is present on or near a charging surface of the wireless charging device; and transmitting the first ping based on determined presence of the chargeable device on or near the charging surface.
12. The charging device as described in any of clauses 7-11, wherein presence of the chargeable device on or near the charging surface is determined using a passive ping procedure.
13. A processor-readable storage medium having instructions stored thereon which, when executed by at least one processor of a processing circuit, cause the processing circuit to: transmit a first ping at a first power level through a power transmitting coil in a wireless charging device; until a response is received from a chargeable device or until a ping with a maximum power level has been transmitted: determine whether a voltage measured at the power transmitting coil is modulated with the response; and transmit a next ping at an increased power level through the power transmitting coil in the wireless charging device when the response is not received; and determine a charging configuration for transferring power to the chargeable device when the response is received.
14. The processor-readable storage medium as described in clause 13, wherein the instructions further cause the processing circuit to: determine the charging configuration based on information identifying a capabilities or configuration of the chargeable device provided in the response.
15. The processor-readable storage medium as described in clause 13 or clause 14, wherein the instructions further cause the processing circuit to: determine the charging configuration from information identifying a requested charging current provided in the response.
16. The processor-readable storage medium as described in any of clauses 13-15, wherein the voltage measured at the power transmitting coil is modulated using Amplitude Shift Key (ASK) modulation.
17. The processor-readable storage medium as described in any of clauses 13-16, wherein the instructions further cause the processing circuit to: determine that the chargeable device is present on or near a charging surface of the wireless charging device; and transmit the first ping based on determined presence of the chargeable device on or near the charging surface.
18. The processor-readable storage medium as described in any of clauses 13-17, wherein presence of the chargeable device on or near the charging surface is determined using a passive ping procedure.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A method performed at a wireless charging device, comprising:
transmitting a first ping at a first power level through a power transmitting coil in the wireless charging device;
until a response is received from a chargeable device or until a ping with a maximum power level has been transmitted:
determining whether a voltage measured at the power transmitting coil is modulated with the response; and
transmitting a next ping at an increased power level through the power transmitting coil in the wireless charging device when the response is not received; and
determining a charging configuration for transferring power to the chargeable device when the response is received.

2. The method of claim 1, further comprising:
determining the charging configuration based on information identifying a capabilities or configuration of the chargeable device provided in the response.

3. The method of claim 1, further comprising:
determining the charging configuration from information identifying a requested charging current provided in the response.

4. The method of claim 1, wherein the voltage measured at the power transmitting coil is modulated using Amplitude Shift Key (ASK) modulation.

5. The method of claim 1, further comprising:
determining that the chargeable device is present on or near a charging surface of the wireless charging device; and
transmitting the first ping based on determined presence of the chargeable device on or near the charging surface.

6. The method of claim 5, wherein presence of the chargeable device on or near the charging surface is determined using a passive ping procedure.

7. A wireless charging device, comprising:
one or more charging cells provided on a charging surface of the wireless charging device; and
a controller configured to:
transmit a first ping at a first power level through a power transmitting coil in the wireless charging device;
until a response is received from a chargeable device or until a ping with a maximum power level has been transmitted:
determine whether a voltage measured at the power transmitting coil is modulated with the response; and
transmit a next ping at an increased power level through the power transmitting coil in the wireless charging device when the response is not received; and
determine a charging configuration for transferring power to the chargeable device when the response is received.

8. The charging device of claim 7, wherein the controller configured to:
determine the charging configuration based on information identifying a capabilities or configuration of the chargeable device provided in the response.

9. The charging device of claim 7, wherein the controller configured to:
determining the charging configuration from information identifying a requested charging current provided in the response.

10. The charging device of claim 7, wherein the voltage measured at the power transmitting coil is modulated using Amplitude Shift Key (ASK) modulation.

11. The charging device of claim 7, wherein the controller configured to:
determining that the chargeable device is present on or near a charging surface of the wireless charging device; and
transmitting the first ping based on determined presence of the chargeable device on or near the charging surface.

12. The charging device of claim 7, wherein presence of the chargeable device on or near the charging surface is determined using a passive ping procedure.

13. A processor-readable storage medium having instructions stored thereon which, when executed by at least one processor of a processing circuit, cause the processing circuit to:
transmit a first ping at a first power level through a power transmitting coil in a wireless charging device;
until a response is received from a chargeable device or until a ping with a maximum power level has been transmitted:
determine whether a voltage measured at the power transmitting coil is modulated with the response; and
transmit a next ping at an increased power level through the power transmitting coil in the wireless charging device when the response is not received; and
determine a charging configuration for transferring power to the chargeable device when the response is received.

14. The processor-readable storage medium of claim 13, wherein the instructions further cause the processing circuit to:
determine the charging configuration based on information identifying a capabilities or configuration of the chargeable device provided in the response.

15. The processor-readable storage medium of claim 13, wherein the instructions further cause the processing circuit to:
determine the charging configuration from information identifying a requested charging current provided in the response.

16. The processor-readable storage medium of claim 13, wherein the voltage measured at the power transmitting coil is modulated using Amplitude Shift Key (ASK) modulation.

17. The processor-readable storage medium of claim 13, wherein the instructions further cause the processing circuit to:
determine that the chargeable device is present on or near a charging surface of the wireless charging device; and
transmit the first ping based on determined presence of the chargeable device on or near the charging surface.

18. The processor-readable storage medium of claim 17, wherein presence of the chargeable device on or near the charging surface is determined using a passive ping procedure.
